(19) United States
(12) Patent Application Publication
(10) Pub. No.: US 2015/0332286 A1
(43) Pub. Date: Nov. 19, 2015

(54) SYSTEM AND METHOD IDENTIFYING HOLDERS OR RE-SELLABLE COMMODITIES

(71) Applicant: MASTERCARD INTERNATIONAL INCORPORATED, Purchase, NY (US)

(72) Inventors: Kenny Unser, Fairfield, CT (US); Serge Bernard, Danbury, CT (US); Nikhil A. Malgatti, Stamford, CT (US)

(73) Assignee: MASTERCARD INTERNATIONAL INCORPORATED, Purchase, NY (US)

(21) Appl. No.: 14/276,663

(22) Filed: May 13, 2014

(51) Int. Cl. G06Q 30/02

(52) U.S. Cl. CPC G06Q 30/0201

(57) ABSTRACT

A system for identifying a holder of re-sellable commodities is provided. The system includes one or more data storage devices containing payment card transaction data of a plurality of customers and a filter configured to identify payment card transactions associated with a predetermined re-sellable commodity from the payment card transaction data. The system further comprises one or more additional data storage devices containing at least one of market or industry data related to the predetermined re-sellable commodity. A processor is provided and configured to analyze the card payment transaction data and the market or industry data related to the predetermined re-sellable commodity for identifying a customer likely to be in possession of the predetermined re-sellable commodity.

### CROSS-REFERENCE TO RELATED APPLICATIONS

None.

### FIELD OF INVENTION

Embodiments of the present disclosure relate to systems and methods for identifying cardholders that may possess predetermined re-sellable commodities.

### BACKGROUND

Merchants of many types of re-sellable commodities (e.g. used cars, event tickets, precious metals, jewelry, collectibles, etc.) often face supply or inventory challenges. More specifically, as these types of merchants deal in commodities for which there are no readily available supply chains, acquiring and consistently maintaining sufficient inventory may prove to be costly, time consuming, or otherwise difficult. For example, a used-car dealer may have to aggressively monitor automobile auctions or seek out active private sellers in order to maintain inventory. Collectors of a given commodity may also face similar challenges in locating a willing seller of a particular item of interest. Likewise, for holders of re-sellable commodities, the processes of selling their goods may include generating costly advertisements, which may necessitate ongoing monitoring, requiring a commitment of both time and effort on the part of the seller.

Alternative systems and methods for identifying holders and/or buyers of re-sellable commodities are desired.

### SUMMARY

In embodiments, systems for identifying a holder of re-sellable commodities are provided. An exemplary system may include one or more data storage devices containing payment card transaction data of a plurality of customers, the payment card transaction data including at least customer information and information identifying a category of good or service associated with the transaction. A filter may be provided and configured to identify payment card transactions associated with a predetermined re-sellable commodity from the payment card transaction data. The system further comprises one or more additional data storage devices containing at least one of market and industry data related to the predetermined re-sellable commodity. A processor is provided and configured to analyze the card payment transaction data and the market or industry data related to the predetermined re-sellable commodity for identifying a customer likely to be in possession of, or a customer potentially interested in purchasing, the predetermined re-sellable commodity.

In another embodiment, a computer-implemented method for identifying a holder of re-sellable commodities is provided. The method includes generating a database comprising payment card transactions related to a predetermined re-sellable commodity based on processing payment card transaction data of a plurality customers and merchants, the payment card transaction data including at least customer information, geographical information and information identifying a category of good or service associated with the transaction. A database comprising at least one of market and industry data related to the predetermined re-sellable commodity is also generated. Card payment transaction data and the market or industry data related to the predetermined re-sellable commodity is analyzed for identifying a customer likely to be in possession of the predetermined re-sellable commodity.

### BRIEF DESCRIPTION OF THE DRAWINGS

FIG. 1 illustrates a system architecture within which some embodiments of the present disclosure may be implemented.

FIG. 2 is a functional block diagram of a managing computer system for a payment card service provider in accordance with an exemplary embodiment of the present disclosure.

FIG. 3 illustrates a simplified system for identifying holder and/or buyers of re-sellable commodities from payment card transaction data according to an embodiment of the present disclosure.

FIG. 4 illustrates exemplary transaction record data useful in implementing aspects of the present system and method.

FIG. 5 illustrates an exemplary process flow for analyzing transaction, market and industry data and generating logic for identifying holders and/or buyers of re-salable commodities according to an embodiment of the present disclosure.

FIG. 6 illustrates another exemplary process flow for identifying holders and/or buyers of re-sellable commodities based on payment card transaction data according to an embodiment of the present disclosure.

### DETAILED DESCRIPTION

Disclosed herein are processor-executable methods, computing systems, and related processing useful for identifying cardholders that may possess predetermined re-sellable commodities and/or individuals with a potential interest in purchasing said identified re-sellable commodities from payment card transaction data. Methods according to embodiments of the present disclosure may generate a transaction database for a particular commodity comprising transaction data from a multiplicity of payment card transactions records that include customer information, merchant information, and transaction amounts. Likewise, market and industry databases may be generated for the commodity, which may include indicators of commodity demand, commodity pricing information, supply and demand estimations, industry sales reports and the like. Analysis of this transactional and market data may be used to generate logic (e.g. executable processes) tasked with identifying cardholders possessing, or potentially possessing, re-sellable commodities of interest, and/or identifying potential buyers of the commodity of interest. Accordingly, embodiments of the present disclosure may be used as a tool for locating supply for commodity re-sellers. The generated logic may further be tasked with assigning a probability value or score indicative of, for example, a likelihood of a commodity holder's willingness to sell or a commodity buyer's willingness to purchase (e.g. buy or sell at a particular price, in a particular market, etc.). Further embodiments can be used to link willing buyers and sellers of re-sellable commodities.

Embodiments of the present disclosure are described herein as being directed to systems and methods for identifying buyers and sellers of so-called re-sellable commodities (event tickets, precious metals, used cars, collectibles, jewelry, or other portable property). However, it should be understood that embodiments of the present disclosure can be used to identify buyers and sellers of a variety of goods and services, and are not limited to any particular category or type of good or service.

A “payment card processing system” or “credit card processing network” or “card network”, such as the MasterCard network exists, allowing consumers to use payment cards issued by a variety of issuers to shop at a variety of merchants. With this type of payment card, a card issuer or attribute provider, such as a bank, extends credit to a customer to purchase products or services. When a customer makes a purchase from an approved merchant, the card number and amount of the purchase, along with other relevant information, are transmitted via the processing network to a processing center, which verifies that the card has not been reported lost or stolen and that the card's credit limit has not been exceeded. In some cases, the customer's signature is also verified, a personal identification number is required or other user authentication mechanisms are imposed. The customer is required to repay the bank for the purchases, generally on a monthly basis. Typically, the customer incurs a finance charge for instance, if the bank is not fully repaid by the due date. The card issuer or attribute provider may also charge an annual fee.

A “business classification” is a group of merchants and/or businesses, classified by the type of goods and/or service the merchant and/or business provides. For example, the group of merchants and/or businesses can include merchants and/or businesses which provide similar goods and/or services. In addition, the merchants and/or businesses can be classified based on geographical location, sales, and any other type of classification, which can be used to define a merchant and/or business with similar goods, services, locations, economic and/or business sector, industry and/or industry group.

Determination of a merchant classification or category may be implemented using one or more indicia or merchant classification codes to identify or classify a business by the type of goods or services it provides. For example, ISO Standard Industrial Classification (“SIC”) codes may be represented as four digit numerical codes assigned by the U.S. government to business establishments to identify the primary business of the establishment. Similarly a “Merchant Category Code” or “MCC” is also a four-digit number assigned to a business by an entity that issues payment cards or by payment card transaction processors at the time the merchant is set up to accept a particular payment card. Such classification codes may be included in the payment card transactions records. The merchant category code or MCC may be used to classify the business by the type of goods or services it provides. For example, in the United States, the merchant category code can be used to determine if a payment needs to be reported to the IRS for tax purposes. In addition, merchant classification codes are used by card issuers to categorize, track or restrict certain types of purchases. Other codes may also be used including other publicly known codes or proprietary codes developed by a card issuer, such as NAICS or other industry codes, by way of non-limiting example.

As used herein, the term “processor” broadly refers to and is not limited to a single- or multi-core general purpose processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific integrated Circuits (ASICs), one or more Field Programmable Gate Array (FPGA) circuits, any other type of integrated circuit (IC), a system-on-a-chip (SOC), and/or a state machine.

It is to be understood that a payment card is a card that can be presented by the cardholder (e.g., customer) to make a payment. By way of example, and without limiting the generality of the foregoing, a payment card can be a credit card, debit card, charge card, stored-value card, or prepaid card or nearly any other type of financial transaction card. It is noted that as used herein, the term “customer”, “cardholder,” “card user,” and/or “card recipient” can be used interchangeably and can include any user who holds a payment card for making purchases of goods and/or services. Further, as used herein in, the term “issuer” or “attribute provider” can include, for example, a financial institution (i.e., bank) issuing a card, a merchant issuing a merchant specific card, a stand-in processor configured to act on-behalf of the card-issuer, or any other suitable institution configured to issue a payment card. As used herein, the term “transaction acquirer” can include, for example, a merchant, a merchant terminal, an automated teller machine (ATM), or any other suitable institution or device configured to initiate a financial transaction per the request of the customer or cardholder.

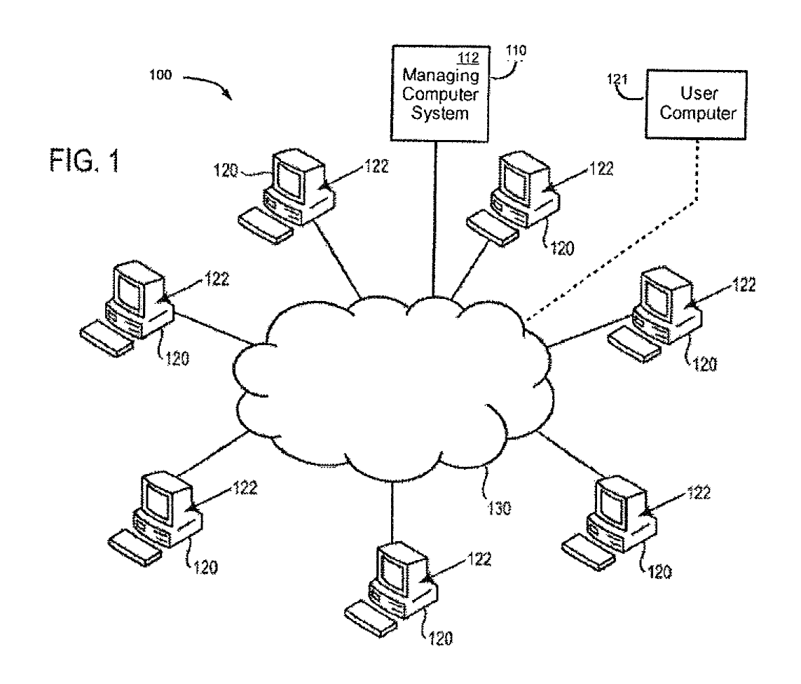

Referring now to FIG. 1, there is shown a high-level diagram illustrating an exemplary system for identifying holders and/or buyers of re-sellable commodities by analyzing payment card transactions according to an embodiment of the disclosure. As shown in FIG. 1, the system 100 includes a managing computer system 110 that includes a data storage device or data warehouse for storing payment card transaction records associated with a card network provider, or payment card service provider 112. Each payment transaction performed by a transaction acquirer and/or merchant 122 having a corresponding merchant computer system 120 is transferred to the managing computer system 110 via a network 130 which connects the computer system 120 of the transaction acquirer or merchant 122 with the managing computer system 110 of the payment card service provider 112. Transactions performed between a customer or cardholder and a transaction acquirer or merchant 122 may comprise point of sale transactions, or electronic point of sale transactions performed via a customer or cardholder computer 121.

The network 130 can be virtually any form or mixture of networks consistent with embodiments as described herein include, but are not limited to, telecommunication or telephone lines, the Internet, an intranet, a local area network (LAN), a wide area network (WAN), virtual private network (VPN) and/or a wireless connection using radio frequency (RE) and/or infrared (IR) transmission to name a few.

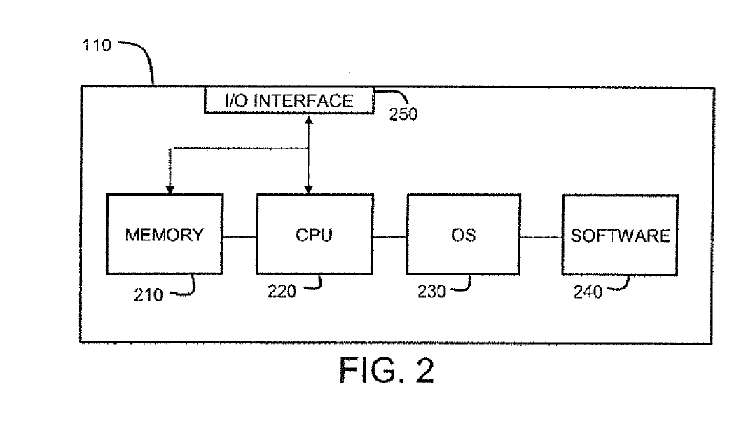

The managing computer system 110 for the payment card service provider 112 as shown in FIG. 2 includes at least one memory device 210 configured to store data that associates identifying information of individual customers, merchants, and transactions associated with payment card accounts. System 110 further includes a computer processor 220, and an operating system. (OS) 230, which manages the computer hardware and provides common services for efficient execution of various logic circuitry including hardware, software and/or programs 240. The processor 220 (or CPU) carries out the instructions of a computer program, which operates and/or controls at least a portion of the functionality of the managing computer system 110. System. 110 further includes device input/output interface 250 configured to receive and output network and transactions data and information to and/or from managing computer system 110 from and/or to peripheral devices and networks operatively coupled to the system. Such devices may include user terminals 121 and/or merchant terminals 120 including point of sale terminals, wireless networks and devices, mobile devices and client/server devices, and user interfaces communicatively coupled over one or more networks for interfacing with managing system 110. The I/O interface 250 may include a query interface configured to accept and parse user requests for information based on the payment card transactions data. In addition, the I/O interface may handle receipt of transactions data and perform transactions based processing in response to receipt of transactions data as a result of a particular purchase via a point of sale terminal, by way of non-limiting example only.

The at least one memory device 210 may be any form of data storage device including but not limited to electronic, magnetic, optical recording mechanisms, combinations thereof or any other form of memory device capable of storing data, which associates payment card transactions of a plurality of transaction acquirers and/or merchants. The computer processor or CPU 220 may be in the form of a stand-alone computer, a distributed computing system, a centralized computing system, a network server with communication modules and other processors, or nearly any other automated information processing system configured to receive data in the form of payment card transactions from transaction acquirers or merchants 122. The managing computer system 110 may be embodied as a data warehouse or repository for the bulk payment card transaction data of multiple customers and merchants. In addition, the computer system 120 or another computer system 121 (e.g. user computer of FIG. 1) connected to computer system 110 (via a network such as network 130) may be configured to request or query the managing computer system 110 in order to obtain and/or retrieve information relating to categories of customers, merchants, and services associated therewith, based on information provided via the computer system 120 or 121 and profiling of the transaction data contained in computer system 110 according to the particular query/request.

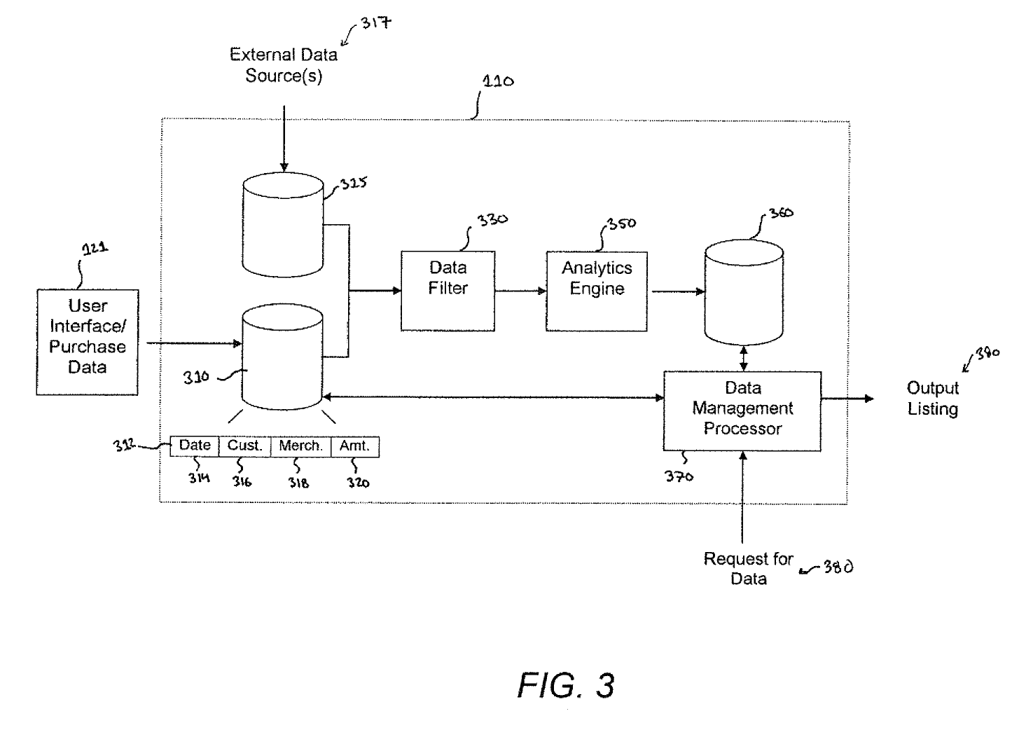

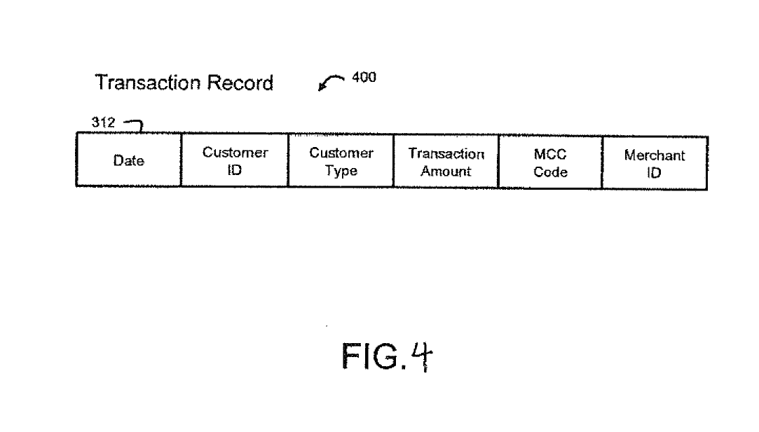

Referring now to FIG. 3, there is shown a system block diagram and operational flow for identifying holder and/or buyers of re-sellable commodities using cardholder transaction data, as well as industry and market data according to an embodiment of the disclosure. A database 310 containing a multiplicity of transaction data is included in managing computer system 110 (FIGS. 1 and 2). In one embodiment, database 310 comprises commodity-specific transaction data. This data may be generated from filtering generalized payment card transaction data. Payment card transactions records 312 may be obtained via various transaction mechanisms, such as credit and debit card transactions between customers and merchants originating via a cardholder terminal or computer 121 (e.g. a personal computer). Payment card transaction records 312 may include transaction date 314 as well as customer information 316, merchant information 318 and transaction amount 320. Customer information 316 may further include customer account identifier (ID) and customer type, as provided in an exemplary transaction record illustrated in FIG. 4. This information may originate from, for example, passive means, such as ISO 8583 information from all payment card purchases. Additional information regarding the details of a cardholder's transaction history may be provided to the card network by, for example, clearing addenda received after purchases have been completed, and may further populate database 310.

The system further includes one or more market and industry databases, embodied herein as database 315. Database 315 includes commodity-specific market data and industrial data. Market data may include, for example, indicators of commodity demand, including commodity pricing, commodity sales volume, and an analysis of supply and demand (e.g. comparing “for sale” vs. “wanted” advertisements, etc.). Industry-related data stored on database 315 may include, for example, industry reports relating to commodities sales, in-market data for sampling commodities brokers, as well as legal data relating to any possible restrictions or hindrances regarding the resale of a particular commodity. Market and industry data may be generated by any suitable means, such imported from external data sources 317 (e.g. market/industry analysis providers), or may be generated through an internal analysis of transaction database 310.

As described above, embodiments of the present disclosure may be used to identify holders of re-sellable commodities via analysis of payment card transaction data. In order to identify relevant transactions payment card transaction data stored in database 310 as well as market and industry data stored in database 315 may be subject to a filtering operation 330 according to the requirements of a particular application in order to selectively identify transactions relating to a commodity of interest. By way of non-limiting example only, the transactions data may be filtered according to different rules or targeting criteria, such as commodity type for targeted analysis. In other embodiments, filtering may be aimed at other forms of data, such as merchant ID numbers, card network codes, transaction dates, transaction type codes, user-provided information, and the like. Further filtering (e.g. by geographical location, e.g. region, state, county, city, zip code, street) may be applied to further target particular aspects of the transaction data for given applications. Still further, filtering according to a particular time range (according to need and/or availability, seasonal events, etc.) may be implemented.

Filtered transaction data is provided to one or more processors, embodied in the illustrated system as analytics engine 350, for further refinement. Analytics engine 350 utilizes statistical analyses and techniques applied to the payment card transaction data to analyze the payment card transactions records to determine relationships, patterns, and trends between and among the various transaction records in order to predict future transactions and estimated times and frequencies associated with such transactions. Such statistical analyses may be targeted to particular subsets of the transactions data, including by way of non-limiting example, one or more particular geographic regions, business categories, customer categories, product or service types, and purchasing frequencies. The transaction records may be processed and segmented into various categories in order to determine purchasers of a given commodity, purchasing frequencies, and drivers or factors affecting purchasing frequency or purchase pricing, by way of non-limiting example. It is to be understood that implementation of the present disclosure may be performed without obtaining personally identifiable (private) data such that the results are not personalized. This enables maintaining privacy of a given user's identity unless the user opts-in to making such data available. In some implementations, the user data is anonymized to obscure the user's identify. For example, received information (e.g. user interactions, location, device or user identifiers) can be aggregated or removed/obscured (e.g., replaced with random identifier) so that individually identifying information is anonymized while still maintaining the attributes or characteristics associated with particular information and enabling analysis of said information. Additionally, users can opt-in or opt-out of making data for images associated with the user available to the system.

The analytics engine may utilize independent variables as well as dependent variables representative of one or more purchasing events, customer types or profiles, merchant types or profiles, purchase amounts, and purchasing frequencies, by way of example only. The analytics engine may use models such as regression analysis, correlation, analysis of variances, time series analysis, determination of frequency distributions, segmentation and clustering applied to the transactions data in order to determine and predict the effect particular categories of data have on other categories.

In one embodiment, analytics engine 350 is configured analyze commodity reseller markets (e.g. ticket resellers, used car dealers or other vehicles, jewelry, etc.) to profile and categorized the filtered transaction data according to logical relationships for the purpose of identifying market opportunities. For example, given an exemplary commodity of baseball tickets, transaction data analyzed by analytics engine 350 may indicate that late season baseball tickets for playoff contenders may resell at a premium over face value. Likewise, given an exemplary commodity of automobiles, engine 350 may identify a strong market for used convertible cars in late spring.

Analytics engine 350 is further configured to identify cardholders that have transaction activity suggesting they have purchased a particular re-sellable commodity in the past. For example, a cardholder may have made a purchase at the Yankee Stadium box office the day playoff tickets went on sale. Further analytics may include establishing estimated market geographies or boundaries. Establishing market boundaries may be achieved utilizing merchant geography groupings that may include city, state or country information. Likewise, standard statistical analysis may be employed, including, for example, clustering, segmentation, raking and the like for estimating market boundaries.

Further still, external data may be used, including Nielsen Designated Market Area (DMA) data, specific market information on utilities, and Metropolitan Statistical Area (MSA). Data may also be analyzed to identify opportunities for resale within each geographic market. For example, retail commodity sales data captured in transaction data may be used to estimate demand. Likewise, external data may be used to make an informed assessment of demand. Identified market opportunities, trends, commodity buyers and sellers, and other related data may be stored on a commodity database 360.

The above-described data analysis may be used to guide the generation of logic (e.g. a computer-implemented process or algorithm) for identifying cardholders in possession of re-sellable commodities. This logic may include sampling techniques, wherein a sample of individuals known to possess re-sellable commodities for “dependent variable” analysis. Sampling may also be used to create profiles of resellers based on data that may include demographics or spending profiles. Outputs of the sampling may include logic to identify cardholders in possession of general or specific commodities. This logic may also be stored in database 360 for continued future use.

The above-generated logic may be used to identify the owners of re-sellable commodities and may attempt to quantify their willingness to sell the commodity. The output of the applied logic may be in the form of a listing or scored file, with indicators of likelihood to possess and/or sell a given commodity. For example, a data management processor 370 may be responsive to a reseller's request 380 for information relating to a particular commodity. Data management processor 370 is operative to link an identified market opportunity, or a request for a particular commodity, with an individual likely to be in possession of the commodity. By way of example only, a request for data may be made by a sporting event ticket reseller. Data management processor 370 may be tasked to identify individuals who may be in possession of the desired commodity in response to the request. Data management processor 370 may output, for example, a dataset 390 that lists individuals and the re-sellable commodity they likely possess, as well as an indication of their likelihood to sell the commodity. Such a likelihood indicator may be based on, for example, a history of similar sales, or may take into consideration, for example, an extended or offered price (e.g. made by a requester) vs. a historical average selling price or other recent selling price data. In one embodiment, the determined average may be calculated as the arithmetic average (mean). In other embodiments, the average may be calculated as the median, mode, geometric mean and/or weighted average. Data management processor 370 may also possess logic to serve commodity holders by providing a means to seek out potential commodity purchasers in a similar fashion. This may be achieved by, for example, identifying cardholders with a history of purchasing a predetermined commodity.

Each or any combination of the modules and components shown in FIG. 3 may be implemented as one or more software modules or objects, one or more specific-purpose processor elements, or as combinations thereof. Suitable software modules include, by way of example, an executable program, a function, a method call, a procedure, a routine or sub-routine, one or more processor-executable instructions, an object, or a data structure. In addition or as an alternative to the features of these modules described above with reference to FIG. 3, these modules may perform functionality described later herein.

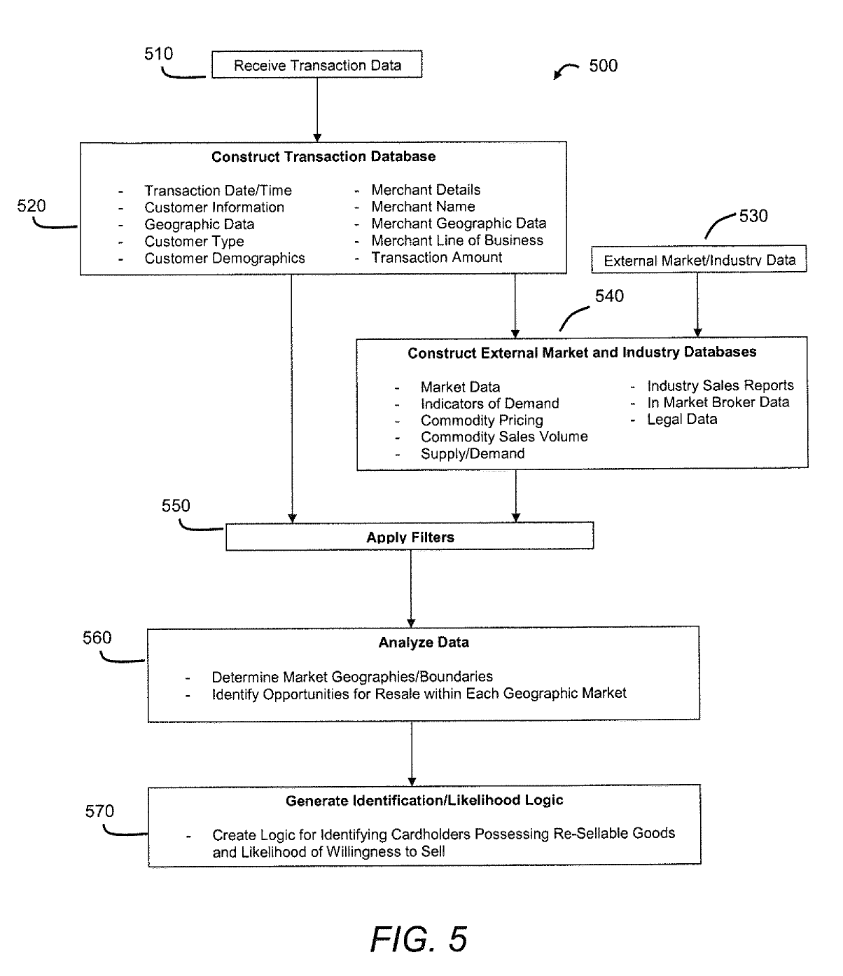

FIG. 5. is a process flow 500 for a system and method for identifying cardholders who may be holders or buyers of a re-sellable commodity of interest. Referring to block 510, payment card transaction data is received by, for example, a card network. From this received transaction data, a transaction database may be constructed (block 520). A transaction database may consist of cardholder transactions, including generalized data, such as date, time and amount, as well as customer information. Customer information may include customer account identification, customer geography, customer type (business/consumer) and other customer demographics. Merchant information may also be obtained including, but not limited to merchant name, merchant geographical data, line of business, etc.

External market and industry data (block 530) may be obtained from third party providers or independent research, by way of example only. This data may be used to create external market and industry databases in block 540. External market databases may include market data and industrial data. Market data may include indicators of demand, including commodity pricing, commodity sales volume, and an analysis of supply and demand (e.g. “for sale” vs. “wanted” advertisements, etc.). Industry data may include, for example, industry reports about commodities sales, in market data for sampling commodities brokers, as well as legal data relating to any possible restrictions or hindrances regarding the resale of a particular commodity.

In block 550 a filtering process may be performed, which may include temporal filtering which may vary based on need or available data.

Referring to block 560, filtered data is subjected to several analytical operations. For example, market geographies or boundaries may be established. Establishing market boundaries may be achieved utilizing merchant geography groupings that may include city, state or country information. Likewise, standard statistical analysis may be employed, including, for example, clustering, segmentation, raking and the like for estimating market boundaries. Further still, external data may be used, including Nielsen Designated Market Area (DMA) data, specific market information on utilities, and Metropolitan Statistical Area (MSA). Data may also be analyzed to identify opportunities for resale within each geographic market. For example, retail commodity sales data captured in transaction data may be used to estimate demand. Likewise, external data may be used to make an informed assessment of demand.

This data analysis may be used to guide the generation of logic (block 570) for identifying cardholders in possession of re-sellable commodities. This logic may include sampling techniques, wherein a sample analysis is made of individuals known to possess re-sellable commodities for the purposes of performing “dependent variable” analysis. Sampling may also be used to create profiles of resellers based on data that may include demographics or spending profiles.

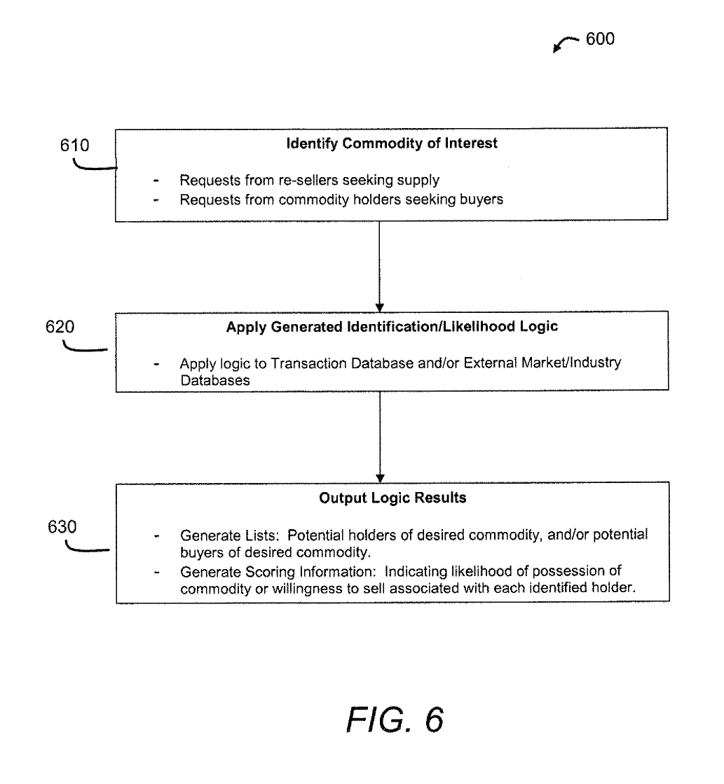

Referring generally to FIG. 6, the above-generated logic may be used in a process 600 for identifying the owners of re-sellable commodities and their likelihood of having a willingness to sell. In block 610, a commodity of interest is identified. This may be the result of a commodity reseller requesting information on holders of a specific commodity, or may constitute an inquiry by a holder of a commodity seeking potential buyers. In block 620, the above-described generated logic is applied to the commodity database, the transaction database, and/or the market/industry databases. Depending on the request for data, the application of the logic may result in a listing of individuals and the re-sellable commodity they likely possess, as well as an indication of their likelihood to sell the commodity. As set forth above, this indicator may be based on, for example, a history of similar sales, or may take into consideration an offered price vs. average or recent selling prices of similar commodities. Likewise, the application of logic may be used to generate a list of potential commodity buyers at the request of a commodity holder.

The flow charts described herein do not imply a fixed order to the steps, and embodiments of the present invention may be practiced in any order that is practicable. In embodiments, one or more steps of the methods may be omitted, and one or more additional steps interpolated between described steps. Note that any of the methods described herein may be performed by hardware, software, or any combination of these approaches. For example, a non-transitory computer-readable storage medium may store thereon instructions that when executed by a processor result in performance according to any of the embodiments described herein. In embodiments, each of the steps of the methods may be performed by a single computer processor or CPU, or performance of the steps may be distributed among two or more computer processors or CPU's of two or more computer systems. In embodiments, one or more steps of a method may be performed manually, and/or manual verification, modification or review of a result of one or more processor-performed steps may be required in processing of a method.

The embodiments described herein are solely for the purpose of illustration. Those in the art will recognize that other embodiments may be practiced with modifications and alterations limited only by the claims.

1. A system for identifying a holder of re-sellable commodities comprising:
one or more data storage devices containing payment card transaction data of a plurality of customers, the payment card transaction data including at least customer information and information identifying a category of good or service associated with the transaction;
a filter configured to identify payment card transactions associated with a predetermined re-sellable commodity from the payment card transaction data;
one or more data storage devices containing at least one of market or industry data related to the predetermined re-sellable commodity;
one or more processors;
a memory in communication with the one or more processors and storing program instructions, the one or more processors operative with the program instructions to:
analyze the card payment transaction data and the market or industry data related to the predetermined re-sellable commodity for identifying a customer likely to be in possession of the predetermined re-sellable commodity.

2. The system of claim 1, wherein the market or industry data includes indicators of commodity demand, commodity pricing information, and supply estimations.

3. The system of claim 1, wherein the memory further comprises instructions for calculating a probability value indicative of an identified customer's willingness to sell the predetermined re-sellable commodity in their possession.

4. The system of claim 3, wherein the calculation of the probability value includes analyzing historical selling prices of the predetermined re-sellable commodity.

5. The system of claim 4, wherein the calculation of the probability value includes comparing historical selling prices of the predetermined re-sellable commodity to an identified offer price.

6. The system of claim 1, wherein the memory further comprises instructions for analyzing the card payment transaction data and the market or industry data related to the predetermined re-sellable commodity for identifying a potential buyer of the predetermined re-sellable commodity.

7. The system of claim 6, wherein the step of identifying a potential buyer of the predetermined re-sellable commodity includes identifying customers with a history of card payment transactions associated with the predetermined re-sellable commodity.

8. A computer-implemented method for identifying a holder of re-sellable commodities, the method comprising:
generating a database comprising payment card transactions related to a predetermined re-sellable commodity based on processing payment card transaction data of a plurality customers and merchants, the payment card transaction data including at least customer information, geographical information and information identifying a category of good or service associated with the transaction;
generating a database comprising at least one of market or industry data related to the predetermined re-sellable commodity;
analyzing the card payment transaction data and the market or industry data related to the predetermined re-sellable commodity for identifying a customer likely to be in possession of the predetermined re-sellable commodity.

9. The method of claim 8, wherein the market or industry data includes indicators of commodity demand, commodity pricing information, and supply estimations.

10. The method of claim 8, further comprising the step of calculating a probability value indicative of an identified customer's willingness to sell the predetermined re-sellable commodity in their possession.

11. The method of claim 10, wherein the step of calculating the probability value includes analyzing historical selling prices of the predetermined re-sellable commodity.

12. The method of claim 11, wherein the step of calculating the probability value includes comparing historical selling prices of the predetermined re-sellable commodity to an identified offer price.

13. The method of claim 8, further comprises the step of analyzing the card payment transaction data and the market or industry data related to the predetermined re-sellable commodity for identifying a potential buyer of the predetermined re-sellable commodity.

14. The method of claim 13, wherein the step of identifying a potential buyer of the predetermined re-sellable commodity includes identifying customers with a history of card payment transactions associated with the predetermined re-sellable commodity.
